(19) United States
(12) Patent Application Publication
(10) Pub. No.: US 2013/0329115 A1
(43) Pub. Date: Dec. 12, 2013

(54) CASE FOR PORTABLE ELECTRONIC DEVICE

(71) Applicant: John Palmeri, Middletown, NY (US)

(72) Inventor: John Palmeri, Middletown, NY (US)

(73) Assignee: RHP Multimedia Corp., Middletown, NY (US)

(21) Appl. No.: 13/984,204

(22) PCT Filed: Jun. 19, 2012
(86) PCT No.: PCT/US12/43184

§ 371 Date: Aug. 27, 2013

Related U.S. Application Data
(60) Provisional application No. 61/499,073, filed on Jun. 20, 2011.

(51) Int. Cl. H04N 5/238

(52) U.S. Cl. CPC H04N 5/238
USPC 348/335

(57) ABSTRACT

A case for a portable electronic device having a camera component can include a housing suitable for coupling with the portable electronic device. The housing can have an opening configured to allow light to pass therethrough. The case can also include a light-redirecting component integrated with the housing and configured to receive the light passing through the opening and redirect the light to the camera component.

### CROSS-REFERENCE TO RELATED APPLICATION

The present application claims the benefit of U.S. Provisional Patent Application Ser. No. 61/499,073, which is titled “ELECTRONIC DEVICE CASE WITH MIRROR” and was filed on Jun. 20, 2011, the content of which is hereby incorporated by reference herein in its entirety.

### TECHNICAL FIELD

The disclosed technology pertains to cases for portable electronic devices, and more particularly to cases having integrated light-redirecting components or assemblies, e.g., mirrors or prisms, for enhanced image and/or video capture and processing thereof.

### BACKGROUND

To capture images and/or video using a portable electronic device, such as an Apple iPhone® or iPad® or any tablet computer or personal digital assistant (PDA) using an integrated rear-facing camera, a user would typically need to hold the device vertically in front of him or her due to the camera lens being located at the backside of the device and the viewing screen on the opposite side of the device. Such action generally draws attention from onlookers and may alert certain people to the fact that they are having their picture or video taken by the user. This could also be uncomfortable for the person taking the picture and/or video or waiting for a long period to get “the perfect shot” while holding the device in a vertical manner.

Consider an example in which a user attends a lecture and would like to capture a video and/or audio recording of the lecture using an electronic device so that he or she can later review the recording. Holding the device in front of him or her to do so would be not only awkward and uncomfortable but would also hinder his or her ability to take notes during the lecture.

Thus, there remains a need for an improved case for portable electronic devices, particularly with regard to capturing images and/or video using such a device.

### BRIEF DESCRIPTION OF THE DRAWINGS

FIG. 1 illustrates a first arrangement of a first example of a portable electronic device and a case therefor in accordance with embodiments of the disclosed technology.

FIG. 2 illustrates a second arrangement of the first example of a portable electronic device and case therefor illustrated in FIG. 1.

FIG. 3 illustrates an exploded view of the portable electronic device case illustrated in FIGS. 1 and 2.

FIG. 4 illustrates an example of the portable electronic device and case therefor illustrated in FIGS. 1-3 being used to capture images and/or video in accordance with embodiments of the disclosed technology.

FIG. 5 illustrates a second example of a portable electronic device and a case therefor in accordance with embodiments of the disclosed technology.

FIG. 6 illustrates an example of the portable electronic device and case therefor illustrated in FIG. 5 being used to capture images and/or video in accordance with embodiments of the disclosed technology.

FIG. 7 further illustrates the portable electronic device case illustrated in FIGS. 5 and 6.

FIG. 8 illustrates a first position for a third example of a portable electronic device and a case therefor in accordance with embodiments of the disclosed technology.

FIG. 9 illustrates a second position for the third example of a portable electronic device and case therefor illustrated in FIG. 8.

FIG. 10 illustrates a fourth example of a portable electronic device and a case therefor in accordance with embodiments of the disclosed technology.

FIG. 11 illustrates an example of a more detailed example of a moveable sub-assembly, such as those illustrated in FIGS. 8-10, in accordance with certain embodiments of the disclosed technology.

FIG. 12 illustrates a fifth example of a portable electronic device and a case therefor in accordance with embodiments of the disclosed technology.

FIG. 13 is a flowchart illustrated an example of a method of capturing image and/or video using a portable electronic device and case therefor in accordance with embodiments of the disclosed technology.

### DETAILED DESCRIPTION

Embodiments of the disclosed technology generally include the use of a light-redirecting component or assembly such as a mirror, prism, or other suitable component or assembly to redirect light corresponding to an image or video being captured or recorded by the camera of an electronic device. As used herein, a light-redirecting component generally refers to a particular component, assembly, or sub-assembly configured to receive light, e.g., from an object being photographed and/or videoed, and re-direct the light such that, upon leaving the light-redirecting component, the redirected light is now traveling in a path other than it would have but for the influence of the light-redirecting component.

Implementations of the disclosed technology generally allow a user of a portable electronic device within a case therefor to hold or place the electronic device and case in a more vertical, normal usage manner than can be done with current devices. Such action is typically less conspicuous and/or easier for the user than with current portable electronic device cases. Also, the manner in which a user may hold the electronic device in these embodiments or place the device on a flat surface generally allows for easier manipulation of the controls on the front of the device by the user.

An electronic device case in accordance with embodiments of the disclosed technology may be configured to hold an electronic device, such as the Apple iPhone or iPad, iPad 2, or iPod Touch, or any tablet computer or PDA that has a built-in camera/video recorder at or on the rear of the electronic device, for example. The case may hold the device at an angle from a given plane, such as an artificial plane or physical plane, e.g., the surface of a table or desk, for ease of manipulating the face plate. The angle from the surface may be anywhere from 10 degrees to 35 degrees, for example. In certain embodiments, the camera and/or video recorder component(s) of the device may have a Field Of View (FOV) of approximately 40 degrees vertical and 52 degrees horizontal when held straight up and down. In such embodiments, the device may be rotated substantially 90 degrees left or right and change the image/video capture to a “landscape” format. Other embodiments may provide other FOVs. In some embodiments, a user may be able to perform certain operations with regard to use of the device, e.g., zoom features, which may serve to change or functionally alter a FOV.

Alternatively or in addition to other embodiments described herein, the electronic device case may be used by a user as a shoulder cradle, e.g., to use the device in a hands-free manner.

In certain embodiments, a light-redirecting component, e.g., mirror or prism, may be implemented in connection with a case for an electronic device to enable a user to take pictures and/or record videos while holding the electronic device in a more natural position. The light-redirecting component may be a built-in component or assembly and may be manipulated, e.g., moved, repositioned, and/or partially or fully removed, by the user. In alternative embodiments, the light-redirecting component may be removable. For example, such embodiments may include multiple types of mirrors, each of which may be placed or situated within or in connection with the case.

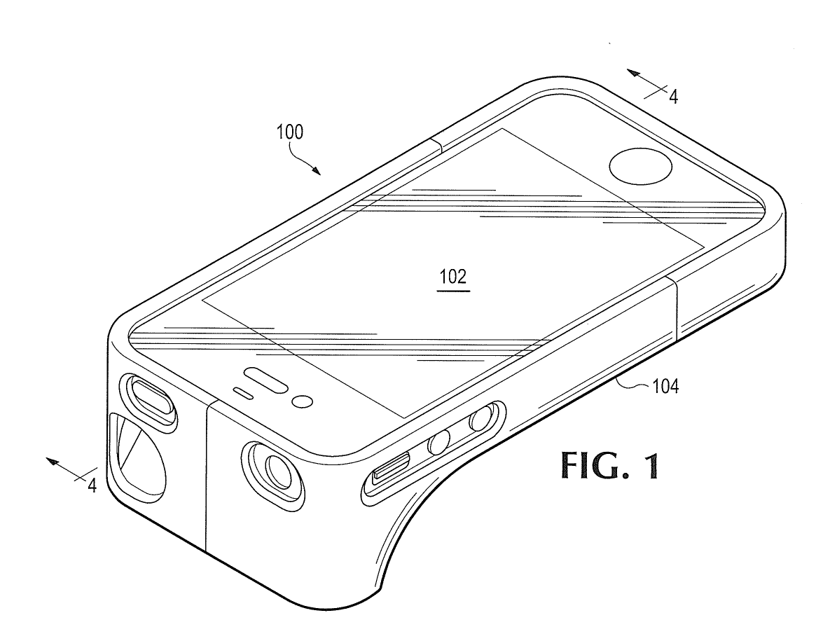

FIG. 1 illustrates a first arrangement 100 of a first example of a portable electronic device 102 and a case 104 therefor in accordance with embodiments of the disclosed technology. The portable electronic device 102 may be a personal digital assistant (PDA), smartphone (e.g., an Apple iPhone or Android-based device), or virtually any other type of portable electronic device. In the first arrangement 100, the device 102 is positioned within the case 104. The device 102 may be secured in that it does not readily fall out of the case 104. In the illustrated arrangement 100, the case 104 may provide the device 102 with protection as well as the other features described below.

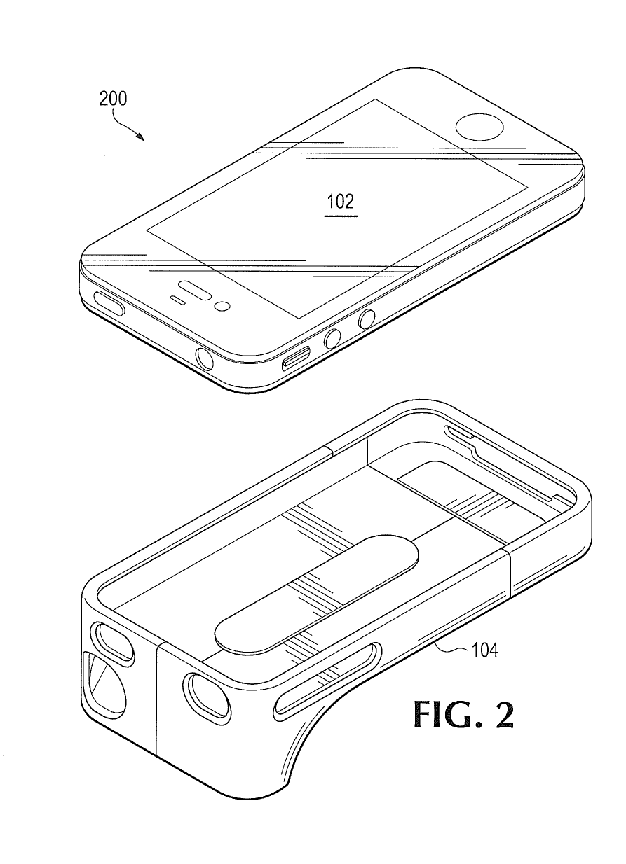

FIG. 2 illustrates a second arrangement 200 of the first example of the portable electronic device 102 and case 104 therefor illustrated in FIG. 1. In the second arrangement 200, the device 102 is fully removed from the case 104. Embodiments of the disclosed technology generally provide a user with the ability to both easily remove the device 102 from the case 104 and also position the device 102 within the case 104, as illustrated in FIG. 1, for example.

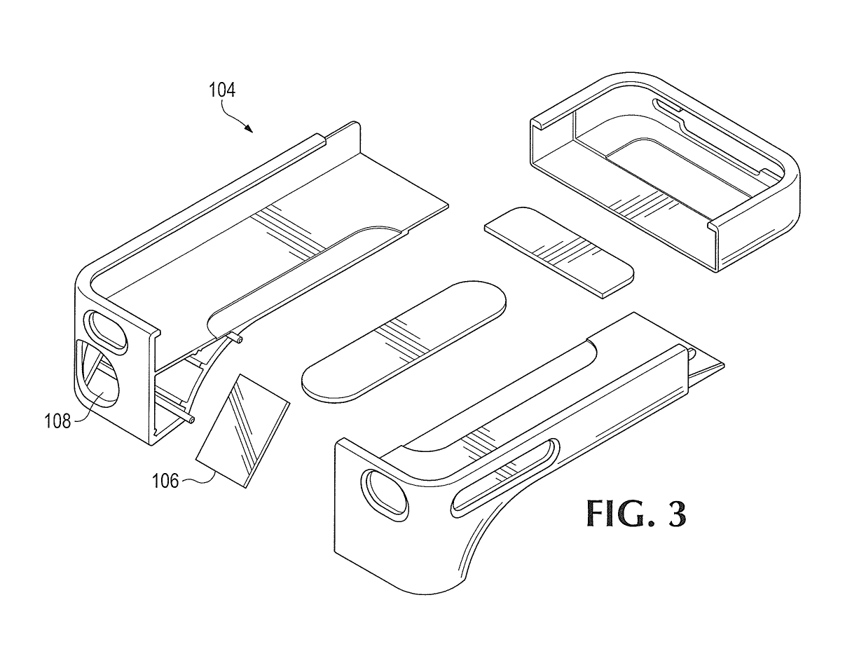

FIG. 3 illustrates an exploded view of the portable electronic device case 104 illustrated in FIGS. 1 and 2. While this view shows a particular arrangement of the case 104, it will be appreciated that the case 104 may be constructed in a variety of manners using any of a number of design and manufacturing techniques and materials, such as high-density polyethylene (HDPE), acrylonitrile butadiene styrene (ABS), high-density rubber or metal, or any combination thereof

In the illustrated example, a light-redirecting component 106, such as a mirror, is integrated with, e.g., within, the case 104. An opening 108 within the case 104 allows for light to easily pass therethrough and onto the light-redirecting component 106 when the case 104 is assembled and the device 102 is positioned therein, as in FIGS. 1 and 2, for example.

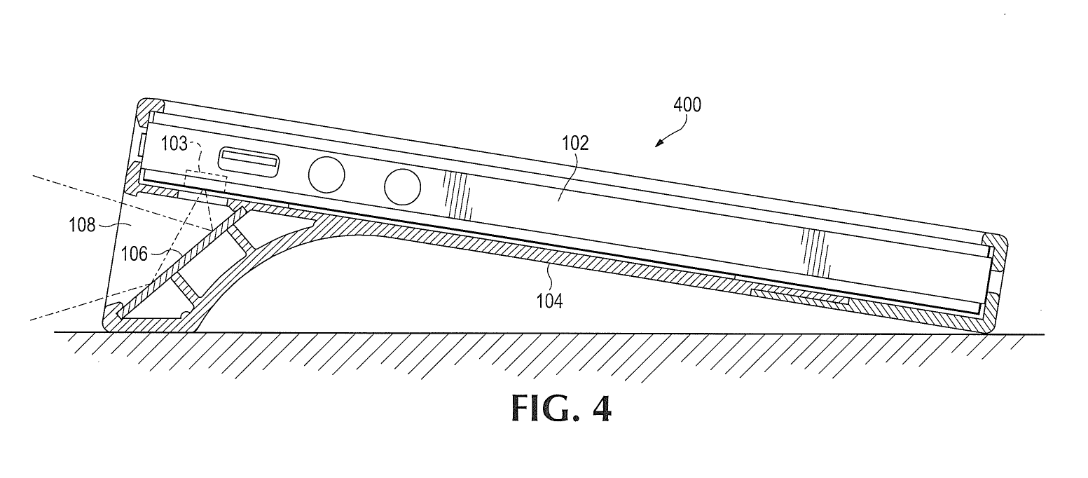

FIG. 4 illustrates an example 400 of the portable electronic device 102 and case 104 therefor illustrated in FIGS. 1-3 being used to capture images and/or video in accordance with embodiments of the disclosed technology. In the example 400, the case 104 has a light-redirecting component 106 and an opening 108 as illustrated in FIG. 3. The opening 108 in the case 104 allows for incoming light to pass therethrough and onto the light-redirecting component 106 such that the light may be redirected, e.g., reflected, and subsequently received by a camera component 103, e.g., camera lens, of a portable electronic device 102 positioned with the case 104. In this manner, the camera component 103 may capture light corresponding to a field of view that a user desires to record in the form of images, video, or both. The size and/or shape of the opening 108 may correspond to the size and/or shape of the camera component 103. For example, the opening 108 may be substantially the same shape as and/or slightly larger than the camera component 103. In some embodiments, a user may be able to perform certain operations with the device, e.g., zoom features, which may serve to reduce or fully eliminate certain issues that may otherwise result from the opening 108 having a size and/or shape that is substantially similar to or less than the camera component 103.

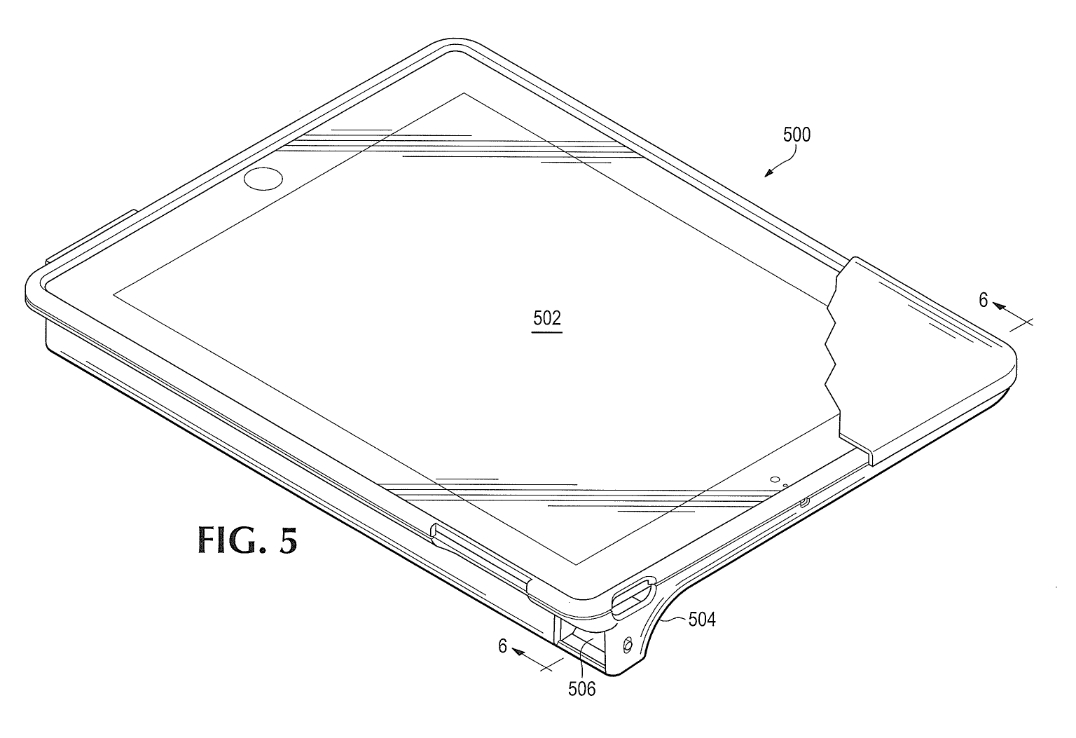

FIG. 5 illustrates a second example 500 of a portable electronic device 502 and a case 504 therefor in accordance with embodiments of the disclosed technology. In the example 500, the case 504 is similar to but larger than the case 104 of FIGS. 1-4 so as to accommodate a larger device 502, such as an Apple iPad, for example. In the illustrated example 500, the case 504 has a light-redirecting component 506 whose functionality is substantially similar to that of the light-redirecting component 106 of FIGS. 3 and 4. The light-redirecting component 506 may be permanently integrated with, e.g., positioned within, the case 504. In alternative embodiments, the light-redirecting component 506 may be removable, e.g., replaceable or swappable with other types of light-redirecting components or assemblies.

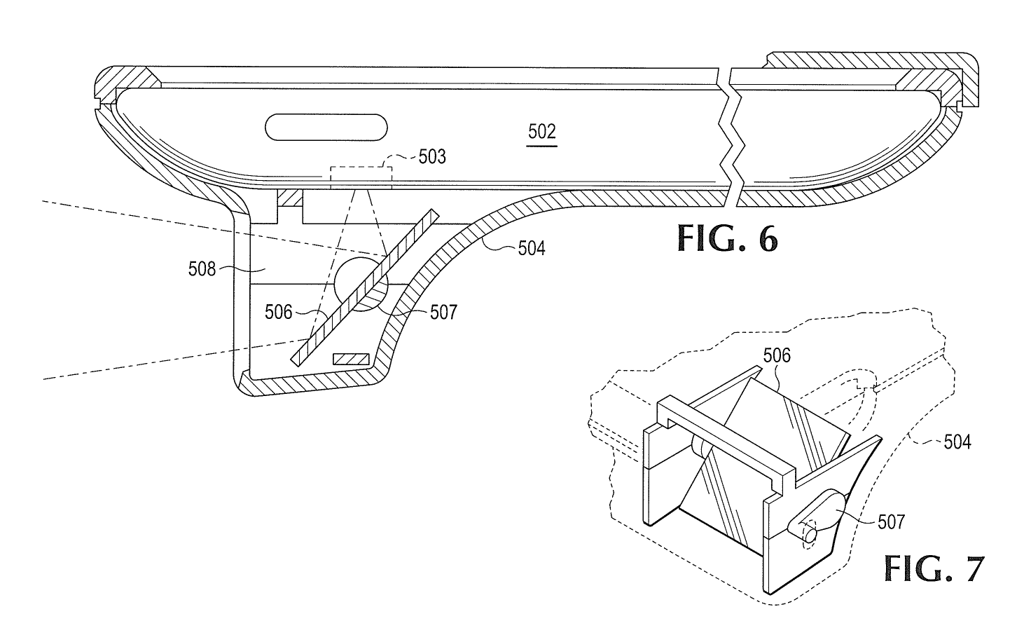

FIG. 6 illustrates an example of the portable electronic device 502 and case 504 therefor illustrated in FIG. 5 being used to capture images and/or video in accordance with embodiments of the disclosed technology. In the example, light may pass through the opening 508 and onto the light-redirecting component 506, which redirects, e.g., reflects, the light to the camera component 503. The example also illustrates a connecting mechanism 507 that may serve to couple the light-redirecting component 506 to the case 504 such that the component 506 may be re-positioned with regard to the opening 508. An example of this is described below with regard to FIG. 7.

FIG. 7 further illustrates the portable electronic device case 504 illustrated in FIGS. 5 and 6. In particular, FIG. 7 shows the light-redirecting component 506 and connecting mechanism 507. In this example, the connecting mechanism 507 includes an axle and a handle such that a user may rotate, e.g., swivel, the light-redirecting component 506, e.g., to change the angle of light redirection, e.g., reflection, to the camera component 503 of the portable electronic device 502.

In certain embodiments, an electronic device case may include a light-redirecting component that is includes a flip-out component incorporated with a stand. Such arrangements may be advantageous for larger electronic devices such as an Apple iPad device, for example.

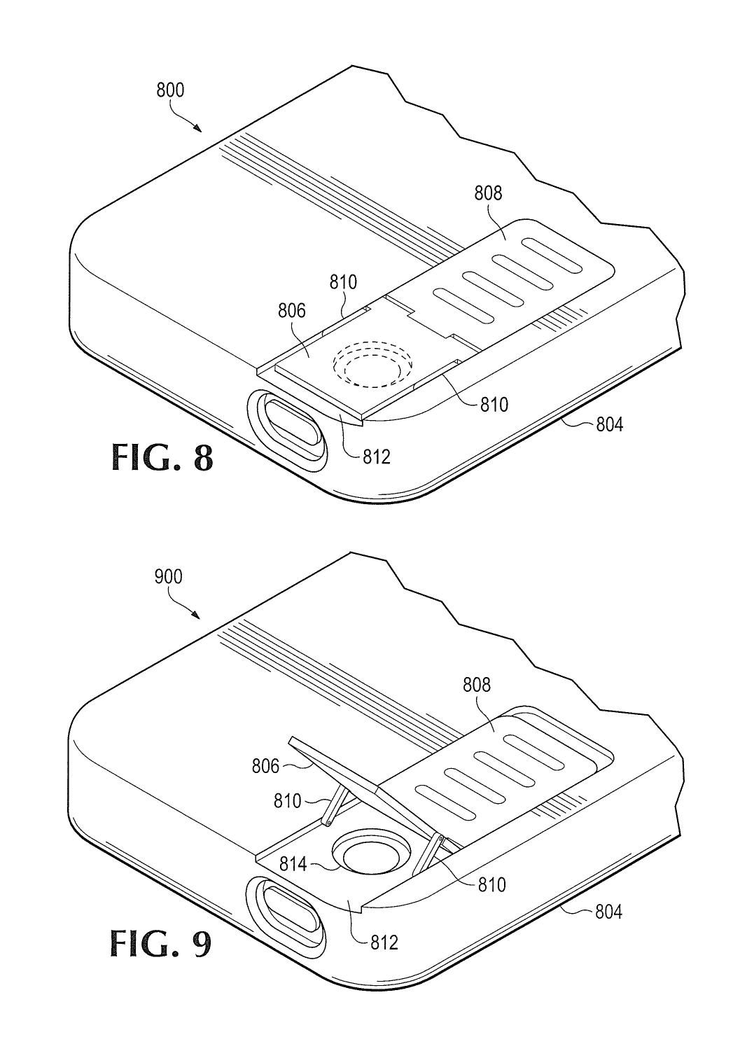

FIG. 8 illustrates a first position 800 for a third example of a portable electronic device and a case 804 therefor in accordance with embodiments of the disclosed technology. In the example, the case 804 has integrated therewith a moveable sub-assembly that includes a sliding component 808 and a light-redirecting component 806, such as a mirror. Two connecting pieces 810 are provided such that, when a user moves the sliding component 808 in a certain direction, the light-redirecting component 806 may move in response thereto. For example, the light-redirecting component 806 may slide along the case 804 and rotate such that light received by the light-redirecting component 806 may be redirected, e.g., reflected, to a camera component. In the example, a “sub-floor” portion 812, discussed further below, is partially exposed.

FIG. 9 illustrates a second position 900 for the third example of a portable electronic device and case therefor illustrated in FIG. 8. In this example, the light-redirecting component 806 has moved and rotated responsive to a user moving, e.g., sliding, the sliding component 808. An angle between the light-redirecting component 806 and a plane of the case 804 is larger than zero but less than ninety degrees. In certain embodiments, the light-redirecting component may lock once a particular angle has been established. Alternatively, a user may be able to easily establish, or re-establish, virtually any angle between zero and ninety degrees. In this example 900, the “sub-floor” portion 812 is more fully exposed and reveals an opening 814 through which light may easily travel.

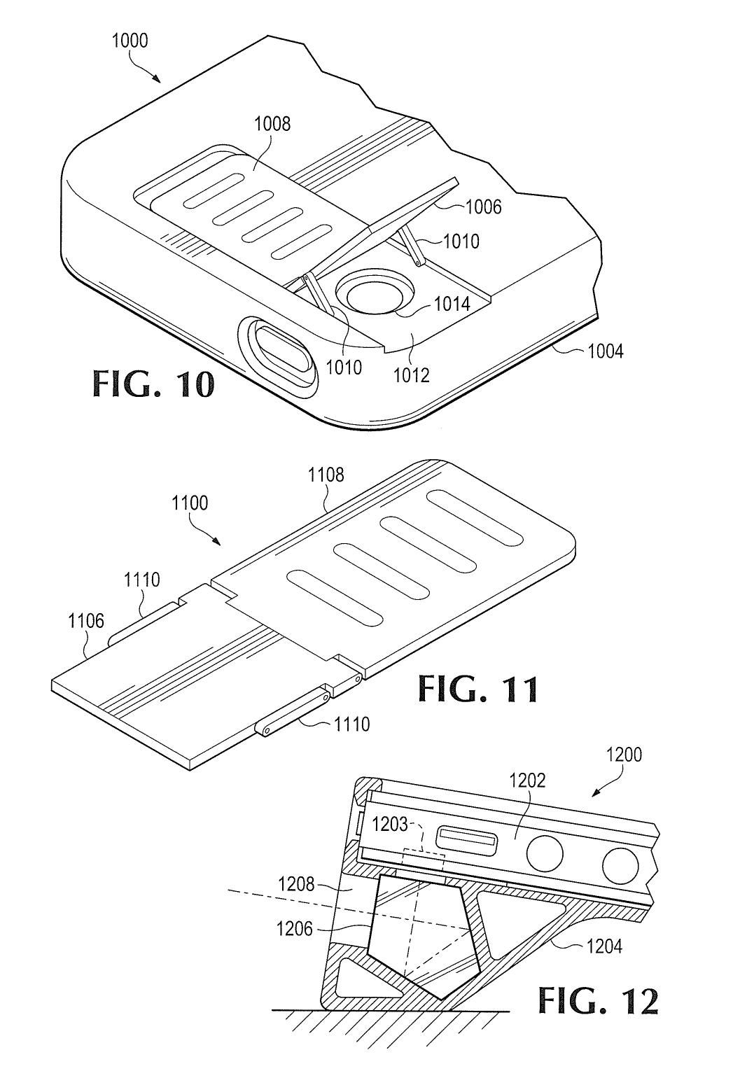

FIG. 10 illustrates a fourth example 1000 of a portable electronic device and a case therefor in accordance with embodiments of the disclosed technology. This example 1000 is similar to the arrangement illustrated in FIG. 9 in that an electronic device case 1004 has integrated therewith a moveable sub-assembly that includes a sliding component 1008, a light-redirecting component 1006, and connecting pieces 1010, and a “sub-floor” portion 1012 having an opening 1014 through which light may easily travel. Whereas the moveable sub-assembly is in a substantially vertical (“portrait”) orientation with regard to the device within the case 804 illustrated in FIG. 9, however, the moveable sub-assembly is in a substantially horizontal (“landscape”) orientation with regard to the device within the case 1004 illustrated in FIG. 10.

FIG. 11 illustrates a more detailed example of a moveable sub-assembly 1100 in accordance with certain embodiments of the disclosed technology. The moveable sub-assembly 1100 is similar to the moveable sub-assemblies described above in that it has a sliding component 1108, a light-redirecting component 1106, and connecting pieces 1110. The connecting pieces may serve to connect the light-redirecting component 1106 to a case, such as the cases 804 and 1104 of FIGS. 8-9 and 10, respectively.

In certain embodiments, the moveable sub-assembly 1100 may be integrated into a portable electronic device case such that it can be easily moved and/or positioned away from an opening within the case when in a closed position, e.g., when flat against the case or otherwise substantially planar with the backside of the case. This functionality may be in place of or in addition to that provided by such a moveable sub-assembly as described above with particular regard to FIGS. 8-10. The sub-assembly 1100 may also have associated therewith a capability of being secured, e.g., locked, in such a “closed” position. In certain embodiments, a user may be able to rotate or otherwise move or re-position the moveable sub-assembly 1100 with respect to the case such that the sub-assembly 110 provides a “portrait” orientation (see, e.g., FIG. 9) when in a first position and a “landscape” orientation (see, e.g., FIG. 10) when in a second position.

An electronic device case in accordance with the disclosed technology may provide a user with ease of use in terms of covert recording. For example, a case with an integrated mirror could be used for covert, inconspicuous, or unobtrusive image capture or live video recording using an electronic device.

In certain embodiments, a software application component of the disclosed technology may include features such as “going to a blank screen” or other information on the screen during image capture or recording. Alternatively or in addition thereto, a small thumbnail of the actual image or video and/or a counter may be provided to confirm for the user that the image is being captured or video recorded.

FIG. 12 illustrates a fifth example 1200 of a portable electronic device 1202 and a case 1204 therefor in accordance with embodiments of the disclosed technology. In this example 1200, the case 1204 has integrated therewith, e.g., within, a pentaprism 1206 configured to receive light through an opening 1208 in the case 1204 and redirect the light to a camera component 1203, e.g., lens.

Certain embodiments may include a software application to perform certain functions, e.g., rotating and mirroring, on the captured image or video to allow the captured image or video to be recorded at a particular position, e.g., a normal viewable position. This is because, when capturing images or recording video through the mirror or a prism, the images/video will typically be upside down and reversed.

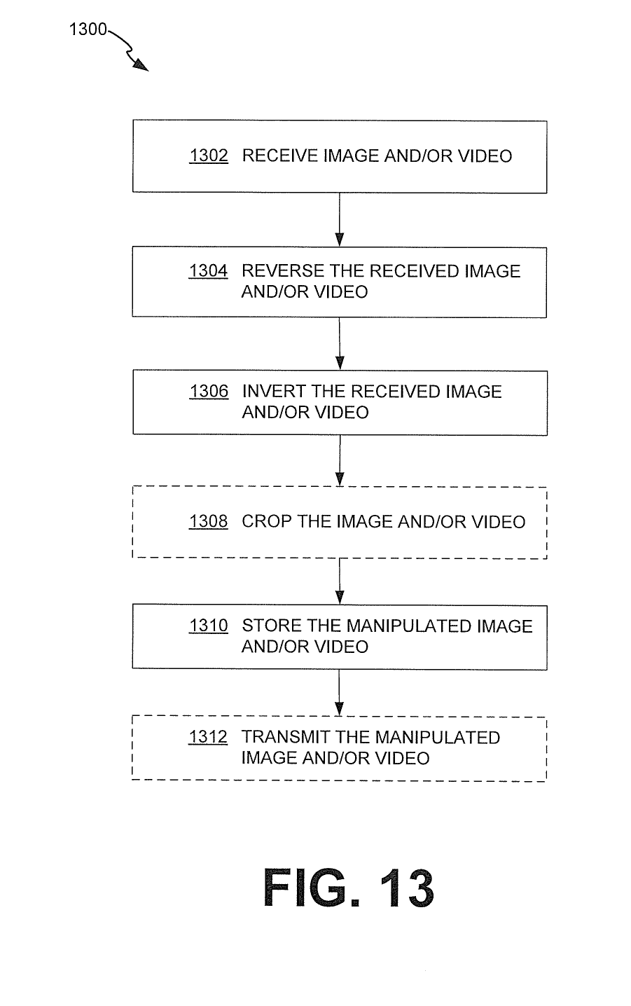

FIG. 13 is a flowchart illustrated an example of a method 1300 of capturing image and/or video using a portable electronic device and case therefor in accordance with embodiments of the disclosed technology. At 1302, the device receives image and/or video in the form of light that is redirected, e.g., reflected, by a corresponding component, e.g., mirror or prism, that is integrated with the case.

At 1304, the device causes the received image and/or video to be reversed. This may be accomplished using any of a number of suitable data manipulation techniques. At 1306, the device causes the received image and/or video to be inverted. As with the reversing operation at 1304, the inverting operation at 1306 may be accomplished using any of a number of suitable data manipulation techniques.

At 1308, the image and/or video may be optionally cropped, e.g., to effectively remove any vignetting resulting from the size and/or shape of the opening in the case, through which light may pass, with respect to the size and/or shape of the camera component that receives the light passing through the opening. The operations at 1304, 1306, and 1308 may be performed fully separately from each other, or they may be performed at least partially concurrently with each other.

At 1310, the device may store the manipulated image and/or video data, e.g., locally and/or at a remote device, network, etc. At 1312, the device may optionally transmit the manipulated data to a particular destination.

General description of a suitable machine in which certain embodiments of the disclosed technology can be implemented

The following discussion is intended to provide a brief, general description of a suitable machine in which certain embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits (ASICs), embedded computers, smart cards, and the like. The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Certain embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other non-transitory, tangible, physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A case for a portable electronic device having a camera component, comprising:
a housing suitable for coupling with the portable electronic device, the housing comprising an opening configured to allow light to pass therethrough; and
a light-redirecting component integrated with the housing and configured to receive the light passing through the opening and redirect the light to the camera component.

2. The case of claim 1, wherein the camera component comprises a lens.

3. The case of claim 1, wherein the light-redirecting component comprises a mirror.

4. The case of claim 3, wherein the mirror is easily removable from the housing.

5. The case of claim 3, wherein the mirror has a substantially convex shape.

6. The case of claim 3, wherein the mirror has a substantially concave shape.

7. The case of claim 3, further comprising a moveable sub-assembly, the moveable sub-assembly comprising the mirror and a sliding component configured to cause the mirror to rotate with respect to the case responsive to a user causing the sliding component to slide along the case.

8. The case of claim 7, wherein the mirror and a plane of the case define an angle between zero degrees and ninety degrees.

9. The case of claim 8, wherein the mirror is configured to be locked in a certain position once the angle is at least substantially at a particular value.

10. The case of claim 7, wherein the moveable sub-assembly provides a landscape orientation for an image corresponding to the light received by the camera component through the opening in the housing.

11. The case of claim 7, wherein the moveable sub-assembly provides a portrait orientation for an image corresponding to the light received by the camera component through the opening in the housing.

12. The case of claim 3, further comprising a mechanism configured to allow a user to rotate the mirror.

13. The case of claim 1, wherein the light-redirecting component comprises a pentaprism.

14. The case of claim 1, wherein the light corresponds to an image to be captured by the camera component.

15. The case of claim 1, wherein the light corresponds to video to be captured by the camera component.

16. The case of claim 1, wherein the housing is configured to allow a user to use the portable electronic device in a hands-free manner.

17. A method, comprising:
a camera component of a portable electronic device receiving light through an opening in a case for the portable electronic device;
the portable electronic device reversing an image corresponding to the light received by the camera component; and
the portable electronic device inverting the image.

18. The method of claim 17, further comprising storing the image.

19. The method of claim 17, further comprising transmitting the image.

20. The method of claim 17, further comprising cropping the image to remove from the image vignetting resulting from the light passing through the opening.
